(19) United States
(12) Patent Application Publication
(10) Pub. No.: US 2009/0218276 A1
(43) Pub. Date: Sep. 3, 2009

(54) FUNCTIONALIZED DIAMOND PARTICLES AND METHODS FOR PREPARING THE SAME

(75) Inventors: Matthew R. Linford, Orem, UT (US); Gaurav Saini, Provo, UT (US)

Correspondence Address: HOLLAND & HART LLP, P.O. Box 11583, 60 E. South Temple, Suite 2000, Salt Lake City, UT, 84110, US

(73) Assignee: Brigham Young University, Provo, UT (US)

(21) Appl. No.: 12/040,638

(22) Filed: Feb. 29, 2008

(51) Int. Cl. B01D 39/02; B32B 5/16; B05D 7/00; C08F 2/46

(52) U.S. Cl. 210/506; 428/407; 427/212; 427/521

(57) ABSTRACT

A functionalized particle is disclosed. The functionalized particle may include a diamond-particle substrate and a coating comprising at least one polymeric compound on at least a surface portion of the diamond-particle substrate, the at least one polymeric compound having at least one amine group. Additionally, the at least one polymeric compound may be at least partially reacted. The at least one polymeric compound may also be at least partially cured. The diamond substrate may be porous. In addition, a second coating coupled to at least a surface portion of the first coating. A separation apparatus may have a stationary phase including a plurality of diamond particles and a coating comprising at least one polymeric compound on at least a surface portion of the plurality of diamond particles is also disclosed. A method for forming a functionalized particle is also disclosed.

### BACKGROUND

Chromatography and solid-phase extraction (“SPE”) are commonly-used separation techniques employed in a variety of analytical chemistry and biochemistry environments. Chromatography and SPE are often used for separation, extraction, and analyses of various constituents, or fractions, of a sample of interest. Chromatography and SPE may also be used for the preparation, purification, concentration, and clean up of samples.

Chromatography and SPE relate to any of a variety of techniques used to separate complex mixtures based on the differential affinities of the fractions of the sample for a mobile phase with which the sample flows, and a stationary phase through which the sample passes. Typically, chromatography and SPE involve the use of a stationary phase that includes a finely powdered solid adsorbent packed into a cartridge or column. A commonly-used stationary phase includes a silica-gel-based sorbent material.

Mobile phases are often solvent-based liquids, although gas chromatography typically involves the use of gaseous mobile phases. Liquid mobile phases may vary significantly in their compositions depending on various characteristics of the sample being analyzed and on the various components sought to be extracted and/or analyzed in the sample. For example, liquid mobile phases may vary significantly in pH and solvent properties. Additionally, liquid mobile phases may vary in their compositions depending on the characteristics of the stationary phase that is being employed. Often, several different mobile phases are employed during a given chromatography or SPE procedure. Stationary phase materials may also exhibit poor stability characteristics in the presence of various mobile phase compositions. The poor stability characteristics of stationary phase materials may limit the number of times a particular stationary phase may be reused prior to disposal, and in many cases, may entirely preclude the use of a particular stationary phase in certain chromatography and SPE procedures. Often, a column and/or stationary phase may become contaminated after use, preventing effective reuse of the column and/or stationary phase. Poor stability characteristics of stationary phase materials may also limit the ability to clean a contaminated column and/or stationary phase without damaging the stationary phase.

### SUMMARY

According to at least one embodiment, a functionalized particle may comprise a diamond-particle substrate and a coating comprising at least one polymeric compound on at least a surface portion of the diamond-particle substrate, the at least one polymeric compound comprising at least one amine group. Additionally, the at least one polymeric compound may be at least partially reacted.

According to an additional embodiment, a functionalized particle may comprise a diamond-particle substrate and a coating comprising at least one polymeric compound on at least a surface portion of the diamond-particle substrate, the at least one polymeric compound comprising at least one amine group. Additionally, the at least one polymeric compound may be at least partially cured.

According to various embodiments, a functionalized particle may comprise a diamond-particle substrate and a coating comprising at least one polymeric compound on at least a surface portion of the diamond-particle substrate, the at least one polymeric compound comprising at least one amine group. Additionally, the diamond-particle substrate may be porous.

According to various embodiments, a functionalized particle may comprise a diamond-particle substrate and a first coating comprising at least one polymeric compound on at least a surface portion of the diamond-particle substrate, the at least one polymeric compound comprising at least one amine group. The functionalized particle may also comprise a second coating coupled to at least a surface portion of the first coating.

According to at least one embodiment, a separation apparatus may comprise a stationary phase, with the stationary phase comprising a plurality of diamond particles and a coating comprising at least one polymeric compound on at least a surface portion of the plurality of diamond particles, the at least one polymeric compound comprising at least one amine group. Additionally, the at least one polymeric compound may be at least partially reacted.

According to additional embodiments, a method for forming a functionalized particle may comprise depositing a coating comprising at least one polymeric compound on at least a portion of a diamond-particle substrate, the at least one polymeric compound comprising at least one amine group, and reacting at least a portion of the at least one polymeric compound.

According to certain embodiments, a method for forming a functionalized particle may comprise depositing a coating comprising at least one polymeric compound on at least a portion of a diamond-particle substrate, the at least one polymeric compound comprising at least one amine group, and curing at least a portion of the at least one polymeric compound.

According to various embodiments, a method for forming a functionalized particle may comprise depositing a coating comprising at least one polymeric compound on at least a portion of a diamond-particle substrate, the at least one polymeric compound comprising at least one amine group, and reacting a second compound with at least a surface portion of the coating.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a perspective view of an exemplary diamond particle according to at least one embodiment.

FIG. 2 is a perspective view of an exemplary diamond particle according to an additional embodiment.

FIG. 3 is a cross-sectional view of a portion of an exemplary diamond particle according to at least one embodiment.

FIG. 4 is a cross-sectional view of a portion of an exemplary diamond particle according to additional embodiments.

FIG. 5 is a cross-sectional view of a portion of an exemplary diamond particle according to additional embodiments.

FIG. 6 is a schematic side cross-sectional view of an exemplary separation apparatus according to at least one embodiment.

FIG. 7 is a flow diagram of an exemplary method for forming a functionalized diamond particle according to an additional embodiment.

FIG. 8 is a flow diagram of an exemplary method for forming a functionalized diamond particle according to an additional embodiment.

FIG. 9 is a flow diagram of an exemplary method for forming a functionalized diamond particle according to an additional embodiment.

FIG. 10 is a flow diagram of an exemplary method for forming a functionalized diamond particle according to an additional embodiment.

FIG. 11 is a flow diagram of an exemplary method for forming a functionalized diamond particle according to at least one embodiment.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

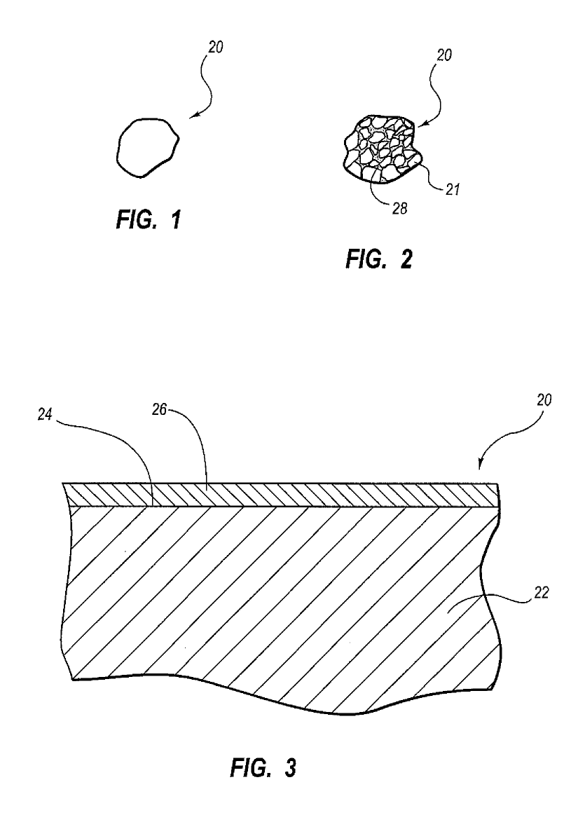

FIG. 1 shows an exemplary diamond body 20 according to at least one embodiment. Diamond body 20 may comprise any suitable diamond material or composite diamond material. Diamond body 20 may additionally comprise carbon in various non-diamond forms, such as, for example, graphitic carbon. Diamond body 20 may be produced through any suitable method, including, for example, by forming carbonaceous material into diamond material under ultra-high pressure and high temperature conditions. Additionally, diamond body 20 may be the product of natural processes or by chemical vapor deposition (“CVD”) processes. Diamond body 20 may also be formed to any suitable shape or size. For example, diamond body 20 may be produced by crushing and/or grinding a diamond starting material to obtain a desired sized diamond body 20. In various embodiments, diamond body 20 may comprise a micron-sized diamond particle, such as, for example, a diamond particle having a diameter of approximately 1-1000 μm. In additional embodiments, diamond body 20 may comprise a nanodiamond particle, such as, for example, a diamond particle having a diameter of approximately 1-1000 nm. Additionally, diamond body 20 may comprise a spherical or an irregular particle.

FIG. 2 shows an exemplary porous diamond body 20 formed from diamond particles 21. In at least one embodiment, diamond body 20, or a diamond material used to produce diamond body 20, may be processed to produce a porous diamond body 20. Diamond body 20 may be formed through any suitable method, including, for example, by sintering diamond particles 21 to produce a porous diamond body 20. More particularly, sintering diamond particles 21 under high temperatures and/or high pressures may cause adjacent diamond particles 21 to become coupled to one another, producing diamond body 20 having recesses 28 defined between adjoining diamond particles 21. As used herein, the terms “couple,” “coupled,” and “coupling,” may refer to any type of joining, attaching, connecting, and/or bonding, without limitation. In an additional embodiment, diamond particles 21 may be coupled together through sintering or any other suitable method to produce a porous diamond mass, which may subsequently be crushed and sized into desired porous diamond bodies 20. In various embodiments, a catalyst may be used to facilitated coupling diamond particles 21 together under various conditions.

In additional embodiments, diamond body 20 may comprise polycrystalline diamond. Diamond body 20 comprising polycrystalline diamond may be formed using any suitable techniques, such as, for example, sintering diamond and/or cubic boron nitride crystal powder under high temperature and high pressure (“HPHT”) conditions. The HPHT conditions may cause diamond crystals or grains to bond to one another to form a skeleton or matrix of diamond through diamond-to-diamond bonding between adjacent diamond particles or other crystalline particles. Additionally, recesses 28 may be formed within the diamond structure due to HPHT sintering.

In various embodiments, a catalyst may be employed for facilitating formation of diamond body 20. Examples of catalysts that may be useful for forming superabrasive diamond body 20 include, without limitation, group VIII Elements (e.g., Fe, Co, Ni, Ru, Rh, Pd, Os, Ir, Pt, etc.), transition metals (e.g., Mn, Cr, Ta, etc.), carbonates (e.g., LiCO₃, NaCO₃, MgCO₃, CaCO₃, SrCO₃, K₂CO₃, etc.), sulfates (e.g., NaSO₄, MgSO₄, CaSO₄, etc.), hydrates (e.g., Mg(OH)₂, Ca(OH)₂, etc.), boron compounds (e.g., B, B₄C, etc.), iron oxides (e.g., FeTiO₃, FeSiO₄, Y₃Fe₅O₁₂, etc.), buckminsterfullerenes (e.g., fullerenes, buckyballs, etc.), TiC_{0.6}, phosphorous, copper, zinc, and/or germanium. Additional examples of catalysts include, without limitation, at least one carbide-forming element from at least one of group IVB, group VB, or group VIB (e.g., Ti, Zr, Hf, V, Nb, Mo, W, etc.), alloyed with at least one element from group IB (e.g., Cu, Ag, Au, etc.).

In at least one example, a so-called solvent catalyst may be employed for facilitating the formation of diamond body 20. Examples of solvent catalysts that may be used for forming diamond body 20 include, without limitation, cobalt, nickel and/or iron. In various examples, a solvent catalyst may dissolve carbon. For example, carbon may be dissolved from the diamond grains or portions of the diamond grains that may graphitize due to high temperature conditions existing during sintering. When a solvent catalyst is cooled, carbon held in solution during sintering may precipitate or otherwise be expelled from the solvent catalyst and may facilitate formation of diamond bonds between abutting or adjacent diamond grains. In certain embodiments, the solvent catalyst may remain in diamond body 20 within recesses 28. In additional embodiments, another material may replace the solvent catalyst that has been at least partially removed from diamond body 20.

FIG. 3 shows a portion of an exemplary diamond body 20 according to various embodiments. As illustrated in this figure, diamond body 20 may comprise a diamond-particle substrate 22 comprising a diamond material. Diamond-particle substrate 22 may additionally comprise various compounds and impurities, including, for example, graphitic carbon. Additionally, at least a portion of diamond body 20 may comprise a coating 26 comprising a polymeric compound. Coating 26 may be disposed on at least a portion of surface 24 of diamond-particle substrate 22. Coating 26 may be disposed upon at least a portion of surface 24. Alternatively, coating 26 may be disposed upon various selected portions of surface 24.

Coating 26 may also be formed to various thicknesses. Additionally, coating 26 may be used to provide diamond body 20 with various properties, including, for instance, various properties enabling diamond body 20 to be suitably used in various chromatography and/or solid phase extraction applications. Additionally, coating 26 may be used to provide a bonding site for additional compounds that may provide diamond body 20 with various properties.

In at least one embodiment, coating 26 may comprise at least one polymeric compound. As used herein, the term “polymeric compound” may include macromonomers, oligomers, and/or various polymers, without limitation. Coating 26 may also be formed from a combination and/or mixture of polymeric compounds. Coating 26 may comprise a polymeric compound having at least one amine group. The amine group on a polymeric compound forming coating 26 may comprise a pendant amine group. Additionally, the polymeric compound in coating 26 may comprise a primary amine group, a secondary amine group, a tertiary amine group, and/or a quaternary amine group. In various embodiments, coating 26 may comprise, for example, polyallylamine, polyethylenimine, polylysine, polyvinylamine, chitosan, trimethylchitosan (i.e., quaternised chitosan), polydiallyldimethyl ammonium chloride (“PDADMA C”), poly(N,N′-dimethylaminoethylmethacrylate), poly(2-vinylpyridine), poly(4-vinylpyridine), polyvinylimidazole, poly(2-(dimethylamino)ethyl acrylate), and/or poly(2-aminoethyl methacrylate)hydrochloride.

Polyethylenimine may be present in coating 26 in a wide range of molecular weights and degrees of branching. Chitosan may be produced by the deacetylation of chitin, and chitin may be deacetylated to various degrees. Polymers in coating 26 may be substantially linear or at least partially branched. Polymers including amines in coating 26 may be protonated, deprotonated, or partially protonated prior to, during, and/or following deposition on surface 24. Additionally, coating 26 may comprise any suitable naturally appearing proteins and/or peptides.

In additional embodiments, coating 26 may comprise a homopolymer and/or a copolymer compound formed from monomer subunits including, for example, allylamine, vinylamine, ethylenimine, vinylamine, lysine, arginine, histidine, 2-isocyanatoethyl methacrylate, aziridine, 1-vinylimidazole, 1-vinyl-2-pyrrolidone, 2-vinylpyridine, 4-vinylpyridine, 2-(dimethylamino)ethyl acrylate, 2-aminoethyl methacrylate hydrochloride, and/or 2-(tert-butylamino)ethyl methacrylate. Additionally, coating 26 may comprise any suitable monomers that may be converted into amines after polymerization by deprotection, hydrolysis, and/or by simple chemical transformation. In various embodiments, coating 26 may comprise monomers based on oxazoline, which may be polymerized to form polyoxazolines and/or which may then be hydrolyzed. Amine-comprising monomers forming a polymeric compound in coating 26 may be protonated, deprotonated, or partially protonated prior to, during, and/or following polymerization.

In at least one embodiment, monomers forming a polymer in coating 26 may be interspersed with other monomer units such as 2-hydroxyethylacrylate, styrene, 1,3-butadiene, methyl methacrylate, methyl acrylate, butyl acrylate, dodecyl methacrylate, acrylonitrile, acrylic acid, methacrylic acid, 4-vinylbenzyl chloride, 4-(trifluoromethyl)styrene, 3-nitrostyrene, vinyl ether, or vinyl acetate.

Coating 26 may comprise a polymeric compound having various chain lengths and various degrees of branching. For example, coating 26 may comprise a polymeric compound having a weight-average molecular weight or number-average molecular weight ranging from approximately 1,000 to approximately 2,500,000. In certain embodiments, coating 26 may comprise a polymeric compound having a weight-average molecular weight or number-average molecular weight ranging from approximately 5,000 to approximately 100,000. Additionally, coating 26 may comprise a polymeric compound having a weight-average molecular weight or number-average molecular weight ranging from approximately 30,000 to approximately 60,000 monomer units. In additional embodiments, coating 26 may comprise polymeric compound having a weight-average molecular weight or number-average molecular weight of less then approximately 1,000. Coating 26 may optionally comprise oligomers having a chain length of from 2 to 100 monomer units in length. As used herein, the term “polymeric compound” includes oligomers as well as polymers of varying chain lengths and molecular weights.

In various embodiments, coating 26 and/or at least a compound forming coating 26 may be cured and/or cross linked to increase the stability of coating 26. For example, coating 26 may be thermally cured by exposing coating 26 to an elevated temperature. In an additional embodiment, coating 26 may also be exposed to a pressure that is higher or lower than an ambient atmospheric pressure to effect curing of coating 26 and/or at least a compound forming coating 26. Additionally, coating 26 may be cured by exposing coating 26 to radiation and/or UV light. Curing may increase the physical and/or chemical stability of coating 26. For example, curing may increase the stability of coating 26 when coating 26 is exposed to harsh conditions, such as high and/or low pH solutions, which may allow a stationary phase comprising diamond bodies 20 to be cleaned and/or otherwise used under harsh conditions, which may include the use of strong solvents, high pH conditions, and/or low pH conditions. The ability to clean a column under harsh conditions may enable reuse of a previously contaminated stationary phase. In at least one embodiment, curing may cause amide linkage to form between various compounds in coating 26. Additionally, curing may cause amide or other linkages to form between various compounds in coating 26 and a surface 24 of diamond-particle substrate 22.

In additional embodiments, a polymer in coating 26 may be allowed to react with another compound in coating 26 before, during, and/or after adsorption of the compound onto diamond-particle substrate 22. Reacting a polymer in coating 26 with another compound in coating 26 may increase the molecular weight of the polymer. Increasing the molecular weight of the polymer may be advantageous in that the higher molecular weight polymer may increase the stability of coating 26 in a variety of conditions.

Coating 26 and/or at least a polymeric compound forming coating 26 may be cross linked through any suitable method, without limitation. For example, a cross-linking agent may be combined with coating 26 during and/or after formation of coating 26 on at least a portion of surface 24 of diamond-particle substrate 22. Alternatively, a cross-linking agent may be combined with a composition forming coating 26 prior to depositing the composition on at least a portion of surface 24 of diamond-particle substrate 22. In additional embodiments, coating 26 and/or at least a polymeric compound forming coating 26 may be cross linked during a curing process, such as a thermal and/or pressure-induced curing process, as described above. Additionally, coating 26 and/or at least a polymeric compound forming coating 26 may be cross linked by exposing coating 26 to radiation. Cross-linking may cause stable bonds to form with amine groups and/or other chemical moieties in a polymeric compound in coating 26, increasing the stability of coating 26. Additionally cross-linking compounds in coating 26 using compounds having epoxy groups may produce hydroxyl groups in and/or on coating 26, resulting in a change in chemical characteristics of coating 26 and providing potential reactive sites on coating 26.

Cross-linking may increase the stability of coating 26 when coating 26 is exposed to harsh conditions, such as high and/or low pH solutions, which may be advantageous in that it may allow a stationary phase comprising diamond bodies 20 to be cleaned and/or otherwise used under harsh conditions, which may include the use of strong solvents, high pH conditions, and/or low pH conditions. The ability to clean a column under harsh conditions may enable reuse of a stationary phase that has previously been contaminated.

In certain embodiments, a cross-linking agent having at least two functional bonding sites may be used to effect cross-linking of at least a portion of coating 26 and/or at least a polymeric compound forming coating 26. For example, a cross-linking agent may comprise a diepoxide compound having at least two epoxide groups, each of which may bond with an amine group. A cross-linking agent having at least two functional bonding sites may bond with at least one amine group on at least two or more polymeric molecules and/or compounds. In an additional embodiment, a cross-linking agent having at least two functional bonding sites may bond with at least one amine group on at least two separate sites on a single polymeric molecule. Additionally, a cross-linking agent having at least two functional bonding sites may bind to a polymeric compound forming coating 26 at only one of the at least two functional binding sites.

Examples of cross-linking agents suitable for cross-linking coating 26 and/or at least a polymeric compound forming coating 26 may include any type of compound containing two or more amine reactive functional groups, including, for example, diisocyanates, diisothiocyanates, dihalides, diglycidyl ethers, diepoxides, dianhydrides, dialdehydes, diacrylates, dimethacrylates, dimethylesters, di- and/or triacrylates, di- and/or trimethacrylates, and/or other diesters. In at least one embodiment, acrylates and/or methacrylates may react with an amine by Michael addition.

In addition, suitable cross-linking agents may include, without limitation, 1,2,5,6-diepoxycyclooctane, phenylenediisothiocyanate, 1,4-diisocyanatobutane, 1,3-phenylene diisocyanate, 1,6-diisocyanatohexane, isophorone diisocyanate, diethylene glycol diglycidyl ether (C₁₀H₁₈O₅), 1,4-butanediol diglycidyl ether, bisphenol A diglycidyl ether, poly(ethylene glycol) diglycidyl ether, poly(propylene glycol) diglycidyl ether, octanedioic acid dichloride (suberic acid dichloride), phthaloyl dichloride, pyromellitic dianhydride, 1,3-butadiene diepoxide, p-phenylene diisothiocyanate, 1,4-dibromobutane, 1,6-diiodohexane, glutaraldehyde, 1,3-butanediol diacrylate, pentaerythritol triacrylate, pentaerythritol tetraacrylate, dipentaerythritol pentaacrylate, 1,6-hexanediol dimethacrylate, and/or propoxylated (3) glyceryl triacrylate. Cross-linking agents may additionally comprise at least one functional group suitable for bonding with non-amine functional groups that may be present on polymers in coating 26.

In at least one embodiment, an epoxide compound such as, for example, 1,2,5,6-diepoxycyclooctane, may have at least one highly strained epoxide ring that may be reactive with various amine groups in coating 26. Various alcohols may be used as effective solvents for amine-epoxide reactions. Reaction of the at least one highly strained epoxide ring with an amine group in coating 26 may result in immobilization of hydrophobic cyclooctyl rings and hydrophilic hydroxyl groups in coating 26, leading to the formation of a mixed-mode stationary phase in coating 26. This type of mixed-mode stationary phase may be employed for various uses, including, for example, retention of proteins and small molecules such as drugs under reverse phase and/or normal conditions in an SPE column.

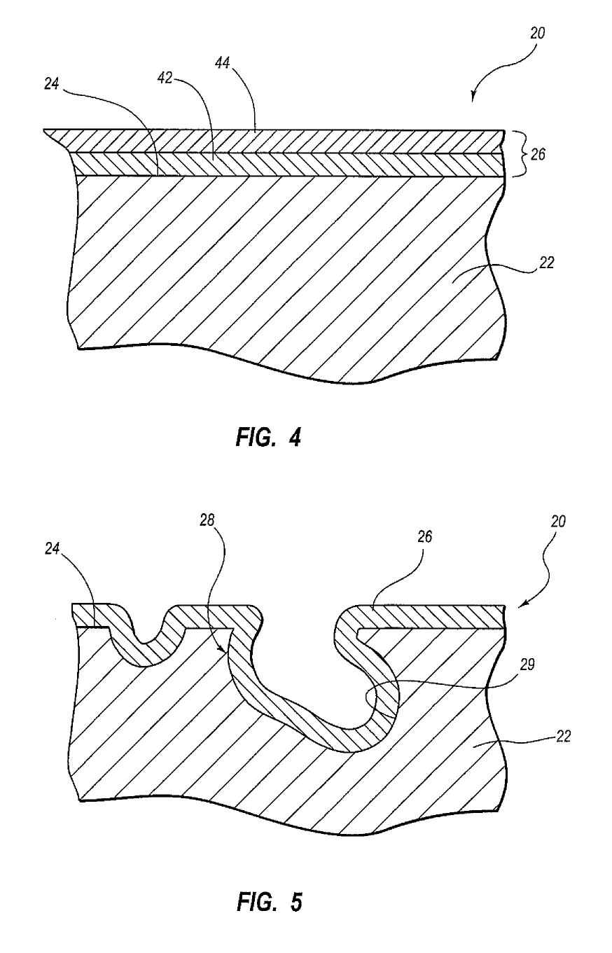

FIG. 4 shows a portion of an exemplary diamond body 20 according to certain embodiments. As illustrated in this figure, diamond body 20 may comprise a coating 26 disposed on at least a portion of surface 24 of diamond-particle substrate 22. In at least one embodiment, coating 26 may comprise two or more coating layers. For example, as shown in FIG. 4, coating 26 may comprise a first coating layer 42 and a second coating layer 44. First coating layer 42 may be disposed on at least a portion of surface 24 of diamond-particle substrate 22. First coating layer 42 may be disposed upon at least a portion of surface 24. Alternatively, first coating layer 42 may be disposed upon various selected portions of surface 24. First coating layer 42 may also be formed to various thicknesses.

First coating layer 42 may provide a bonding site for second coating layer 44 and/or various compounds present within second coating layer 44. In at least one embodiment, first coating layer 42 may comprise at least one polymeric compound. First coating layer 42 may also comprise a combination and/or mixture of polymeric compounds. First coating layer 42 may comprise a polymeric compound have at least one amine group. Additionally, a polymeric compound in first coating layer 42 may comprise a primary amine group, a secondary amine group, a tertiary amine group, and/or a quaternary amine group.

In various embodiments, first coating layer 42 may comprise, for example, polyallylamine, polyethylenimine, polylysine, polyvinylamine, chitosan, trimethylchitosan (i.e., quaternised chitosan), polydiallyldimethyl ammonium chloride (“PDADMAC”), poly(N,N′-dimethylaminoethylmethacrylate), poly(2-vinylpyridine), poly(4-vinylpyridine), polyvinylimidazole, poly(2-(dimethylamino)ethyl acrylate), and/or poly(2-aminoethyl methacrylate) hydrochloride. Polyethylenimine may be present in first coating layer 42 in a wide range of molecular weights and degrees of branching. Chitosan may be produced by the deacetylation of chitin, and chitin may be deacetylated to various degrees. Polymers in first coating layer 42 may be substantially linear or at least partially branched. Polymers including amines polymers in first coating layer 42 may be protonated, deprotonated, or partially protonated prior to, during, and/or following deposition on surface 24. Additionally, first coating layer 42 may comprise any suitable naturally appearing proteins and/or peptides.

In additional embodiments, first coating layer 42 may comprise a homopolymer and/or a copolymer compound formed from monomer subunits including, for example, allylamine, vinylamine, ethylenimine, vinylamine, lysine, arginine, histidine, 2-isocyanatoethyl methacrylate, aziridine, 1-vinylimidazole, 1-vinyl-2-pyrrolidone, 2-vinylpyridine, 4-vinylpyridine, 2-(dimethylamino)ethyl acrylate, 2-aminoethyl methacrylate hydrochloride, and/or 2-(tert-butylamino)ethyl methacrylate. Additionally, coating 26 may comprise any suitable monomers that may be converted into amines after polymerization by deprotection, hydrolysis, and/or by simple chemical transformation. In various embodiments, coating 26 may comprise monomers based on oxazoline, which may be polymerized to form polyoxazolines and/or which may then be hydrolyzed. Amine-comprising monomers forming a polymeric compound in coating 26 may be protonated, deprotonated, or partially protonated prior to, during, and/or following polymerization.

In at least one embodiment, monomers forming a polymer in first coating layer 42 in may be interspersed with other monomer units such as 2-hydroxyethylacrylate, styrene, 1,3-butadiene, methyl methacrylate, methyl acrylate, butyl acrylate, dodecyl methacrylate, acrylonitrile, acrylic acid, methacrylic acid, 4-vinylbenzyl chloride, 4-(trifluoromethyl)styrene, 3-nitrostyrene, a vinyl ether, or vinyl acetate.

Second coating layer 44 may comprise additional compounds and/or polymers disposed on and/or coupled to first coating layer 42. Various compounds in second coating layer 44 may impart certain properties to diamond body 20, enabling diamond body 20 to be suitably used, for example, in various chromatography and/or solid phase extraction applications. Additionally, second coating layer 44 may provide a bonding site for additional compounds that may provide diamond body 20 with additional characteristics. Second coating layer 44 may be disposed upon at least a portion of first coating layer 42. Alternatively, second coating layer 44 may be disposed upon various distinct portions of first coating 42 and/or surface 24 of diamond-particle substrate 22.

In at least one embodiment, second coating layer 44 may comprise at least one polymeric compound. Additionally, second coating layer 44 may also be formed from a combination and/or mixture of polymeric compounds. Examples of compounds that may at least partially form second coating layer 44 include, without limitation, isocyanates, alkyl halides, polyelectrolytes, acyl chlorides, acyl bromides, diacid chlorides, triacid chlorides, diacid bromides, triacid bromides, acyclic anhydrides, cyclic mono anhydrides, cyclic di anhydrides, carboxylic acids, esters, isothiocyanates, aldehydes, ketones, sulfonyl chlorides, monoepoxides, diepoxides, triepoxides, tetraepoxides, polyacrylic acids, and/or polystyrene sulfonates.

Additionally, polyanions, such as, for example, polyacrylic acid, polystyrene sulfonate/sodium salt, polymethacrylic acid, polyaspartic acid, and/or polyglutamic acid may be present in second coating layer 44. Additional compounds that may at least partially form second coating layer 44 include, without limitation, succinic anhydride, glutaric anydride, 1,2-epoxyoctadecane, 1,2-epoxyhexadecane, 1-bromooctadecane, 1-iodobutane, 2-iodobutane, benzylbromide, the NHS (N-hydroxysuccinimide) ester of stearic acid, (R)-(−)-glycidyl methyl ether, (R)-(−)-glycidyl butyrate, phenyl isocyanate, an NHS-ester, methyl stearate, octadecyl isocyanate, dodecyl isocyanate, 1-bromododecane, 1-iodooctane, 1-chlorooctane, acryloyl chloride, acetyl chloride, acrylonitrile, dimethyl malonate, oxalyl chloride, polyglycidyl methacrylate, polyacryloyl chloride, and/or polyvinylbenzylchloride.

In various embodiments, reactions that may be used to bond compounds in second coating layer 44 to first coating layer 42 and/or surface 24 of diamond-particle substrate 22 may include various suitable reactions, without limitation. Various compounds present in second coating layer 44 may be bonded to first coating layer 42 through, for example, a covalent and/or an ionic bond between the various compounds and an amine and/or hydroxyl group present in or on first coating layer 42. Additionally, various compounds may react with various compounds in first coating layer 42, becoming bonded to the compounds in first coating layer 42 and becoming a part of first coating layer 42. As described above, an amine group and/or a hydroxyl group may be present in and/or on first coating layer 42 as a substituent group on at least a compound forming at least a portion of first coating layer 42.

In at least one embodiment, an isocyanate compound may be reacted with an amine group on first coating layer 42 to attach the isocyanate compound to first coating layer 42 through the formation of a urea linkage. An isocyanate compound may, for example, have a general molecular formula R—NCO, where R may be a branched or straight alkyl chain. In certain embodiments, R may include an aromatic ring.

In additional embodiments, an alkyl halide compound may be reacted with an amine group on first coating layer 42 to form a branched or straight N-alkyl amine, N,N-dialkyl amine, and/or N,N,N-trialkyl ammonium salt on first coating layer 42. An alkyl halide compound may, for example, have a general molecular formula R—X, where X may be Cl, Br or I, and R may be a branched or straight alkyl chain. In certain embodiments, R may include an aromatic ring.

In additional embodiments, first coating layer 42 comprising an amine group may be used as a starting point for atom transfer radical polymerization (“ATRP”) and/or other polymerization. First coating layer 42 comprising an amine group may also be used as a starting point for polyelectrolyte deposition.

In additional embodiments, an acyl halide compound, such as acyl chloride and/or acyl bromide, may be reacted with an amine group on first coating layer 42 to attach the acyl halide compound to first coating layer 42 through the formation of an amide linkage. An acyl halide compound may, for example, have a general molecular formula RCOX, where R may be a branched or straight alkyl chain and X may be Cl or Br. In certain embodiments, R may include an aromatic ring.

In additional embodiments, a di and/or tri acid chloride and/or bromide compound may be reacted with an amine group on first coating layer 42 to attach the di and/or tri acid chloride and/or bromide compound to first coating layer 42 through the formation of an amide linkage.

In additional embodiments, an acyclic anhydride compound may be reacted with an amine group on first coating layer 42 to attach the acyclic anhydride compound to first coating layer 42 through the formation of an amide linkage. An acyclic anhydride compound may, for example, have a general molecular formula RCOOCOR′, where R and R′ may each individually be branched or straight alkyl chains. In certain embodiments, R and R′ may each individually include an aromatic ring.

In additional embodiments, a cyclic mono anhydride and/or a cyclic di anhydride compound may be reacted with an amine group on first coating layer 42 to attach the cyclic mono anhydride and/or a cyclic di anhydride compound to first coating layer 42 through the formation of an amide linkage and/or conversion of an amine group into carboxylic acid. A cyclic mono anhydride and/or a cyclic di anhydride compound may also form an imide linkage with an amine (e.g., a secondary amine) and/or a carboxyl group on first coating layer 42.

In additional embodiments, an acid compound may be reacted with an amine group on first coating layer 42 to attach the acid compound to first coating layer 42 through the formation of an amide linkage. An acid compound may, for example, have a general molecular formula RCOOH, where R may be a branched or straight alkyl chain. In certain embodiments, R may include an aromatic ring.

In additional embodiments, an ester compound may be reacted with an amine group on first coating layer 42 to attach the ester compound to first coating layer 42 through the formation of an amide linkage. An ester compound may, for example, have a general molecular formula RCOOR′, where R and R′ may each individually be branched or straight alkyl chains. In certain embodiments, R and R′ may each individually include an aromatic ring.

In additional embodiments, an isothiocyanate compound may be reacted with an amine group on first coating layer 42 to attach the isothiocyanate compound to first coating layer 42 through the formation of a thiourea linkage. An isothiocyanate compound may, for example, have a general molecular formula RNCS, where R may be a branched or straight alkyl chain. In certain embodiments, R may include an aromatic ring.

In additional embodiments, an aldehyde compound may be reacted with an amine group on first coating layer 42 to attach the aldehyde compound to first coating layer 42 through the formation of an aldimine linkage. An aldehyde compound may, for example, have a general molecular formula RCHO, where R may be a branched or straight alkyl chain. In certain embodiments, R may include an aromatic ring.

In additional embodiments, a ketone compound may be reacted with an amine group on first coating layer 42 to attach the ketone compound to first coating layer 42 through the formation of a ketimine linkage. A ketone compound may, for example, have a general molecular formula RCOR′, where R and R′ may each individually be branched or straight alkyl chains. In certain embodiments, R and R′ may each individually include an aromatic ring.

In additional embodiments, a sulfonyl chloride compound may be reacted with an amine group on first coating layer 42 to attach the sulfonyl chloride compound to first coating layer 42 through the formation of a sulfonamide linkage. A sulfonyl chloride compound may, for example, have a general molecular formula RSO₂Cl, where R may be a branched or straight alkyl chain. In certain embodiments, R may include an aromatic ring.

In additional embodiments, a monoepoxide compound may be reacted with an amine group on first coating layer 42 to attach the monoepoxide compound to first coating layer 42 through the formation of an epoxide linkage. A reaction between a monoepoxide compound and an amine group on first coating layer 42 may additionally lead to the formation of amino alcohols on first coating layer 42 and/or in second coating layer 44.

In additional embodiments, a diepoxide, triepoxide, and/or tetraepoxide compound may be reacted with an amine group on first coating layer 42 to attach the diepoxide, triepoxide, and/or tetraepoxide compound to first coating layer 42 through the formation of an epoxide linkage. A reaction between at least one diepoxide, triepoxide, and/or tetraepoxide compound and at least two amine groups on first coating layer 42 may lead to cross-linking of compounds comprising the at least two amine groups in first coating layer 42. A reaction between a plurality of diepoxide, triepoxide, and/or tetraepoxide compounds and a plurality of amine groups on first coating layer 42 may lead to the formation of mixed mode stationary phase on first coating layer 42 and/or second coating layer 44.

FIG. 5 shows a portion of an exemplary diamond body 20 according to additional embodiments. As illustrated in this figure, diamond body 20 may comprise a diamond-particle substrate 22 comprising a diamond material. Additionally, at least a portion of diamond body 20 may comprise a coating 26 comprising a polymeric compound. Coating 26 may be formed on at least a portion of surface 24 of diamond-particle substrate 22. In at least one embodiment, the polymeric compound in coating 26 may have at least one amine group. Additionally diamond-particle substrate 22 may comprise at least one recess 28 defined by recess surface 29 in a portion of diamond-particle substrate 22. Recess 28 may be formed by any suitable method, as described above with reference to FIGS. 1 and 2. In at least one embodiment, recess 28 may comprise a space defined between adjacent and/or coupled diamond particles 21, as shown in FIG. 2.

As shown in FIG. 5, recess 28 may be located on an outer portion of diamond-particle substrate 22 such that recess 28 is open to an exterior of diamond-particle substrate 22. Recess 28 may extend through at least a portion of diamond body 20 and may be connected to additional recesses 28. Additionally, coating 26 may be formed on at least a portion of recess surface 29 defining recess 28. A diamond body 20 comprising recess 28 may have a greater exposed surface area in comparison with a diamond body 20 that does not have recess 28. In other words, surface 29 defining recess 28 may provide diamond body 20 with additional surface area that is exposed to an exterior of diamond body 20.

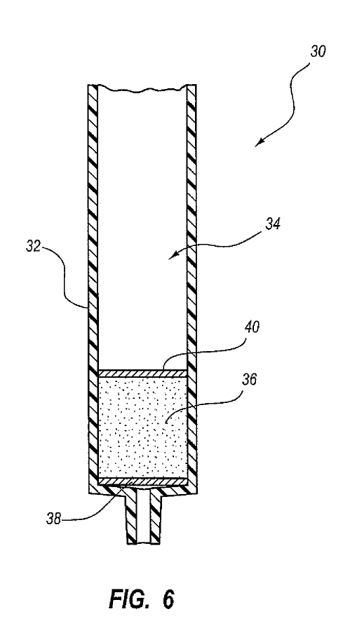

FIG. 6 shows an exemplary separation apparatus 30 according to at least one embodiment. As illustrated in this figure, separation apparatus 30 may comprise a column 32 defining a reservoir 34. Additionally, a stationary phase 36 may be disposed within at least a portion of reservoir 34 of column 32. Stationary phase 36 may comprise a plurality of diamond bodies 20. As described above with reference to FIGS. 2 and 3, diamond bodies 20 may be at least partially coated with coating 26. Additionally, diamond particles may be porous, comprising recesses on their surface, such as recess 28 shown in FIG. 5. In various embodiments, a frit 38 and/or a frit 40 may be disposed in column 32 on either side of stationary phase 36. Frits 38 and 40 may comprise any suitable material that allows passage of a mobile phase and any solutes present in the mobile phase, while preventing passage of diamond bodies 20 present in stationary phase 36. Examples of materials used to form frits 38 and 40 include, without limitation, glass, polypropylene, polyethylene, stainless steel, and/or polytetrafluoroethylene.

Column 32 may comprise any type of column or other device suitable for use in separation processes such as chromatography and solid phase extraction processes. Examples of column 32 include, without limitation, chromatographic and solid phase extraction columns, tubes, syringes, cartridges (e.g., in-line cartridges), and plate containing multiple extraction wells (e.g., 96-well plates). Reservoir 34 may be defined within an interior portion of column 32. Reservoir 34 may permit passage of various materials, including various solutions and solvents used in chromatographic and solid-phase extraction processes.

Stationary phase 36 may be disposed within at least a portion of reservoir 34 of column 32 so that various solutions and solvents introduced into column 32 contact at least a portion of stationary 36. Stationary phase 36 may comprise a plurality of substantially non-porous diamond bodies 20. In an additional embodiment, stationary phase 36 may comprise a plurality of porous diamond bodies 20. A stationary phase 36 comprising porous diamond bodies 20 may have a greater contact surface area in comparison with an equal volume and/or weight of a stationary phase 36 comprising less-porous or non-porous diamond bodies 20. In certain embodiments, frits, such as glass frits, may be positioned within reservoir 34 to hold stationary phase 36 in place, while allowing passage of various materials such as solutions and solvents.

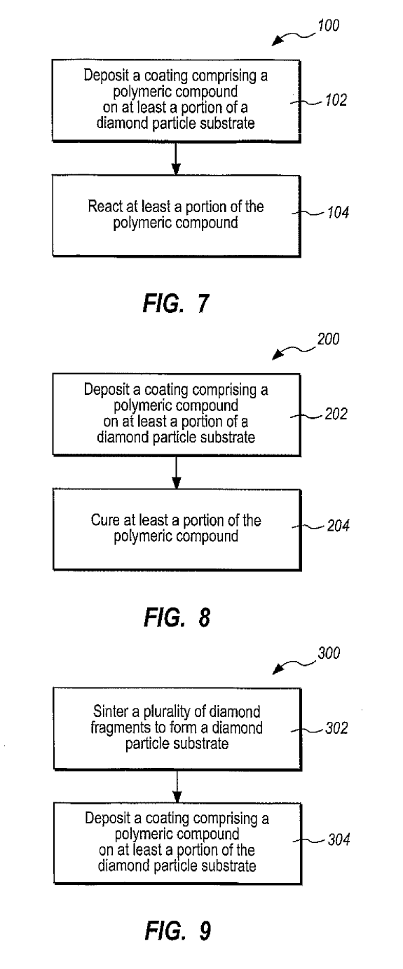

FIGS. 7-11 show various exemplary methods for forming a coating on a surface according various embodiments. FIG. 7 is a flow diagram of an exemplary method 100 for forming a functionalized diamond particle according to at least one embodiment. As illustrated in this figure, at step 102, a coating 26 comprising a polymeric compound may be deposited on at least a portion of a diamond-particle substrate 22 (see e.g., FIGS. 3-5). The polymeric compound may be present in coating 26 alone or as part of a mixture of various compounds. In various embodiments, the polymeric compound may comprise at least one amine group, as described above.

Coating 26 may be disposed upon at least a portion of surface 24, or alternatively, coating 26 may be disposed upon various selected portions of surface 24. Additionally, coating 26 may also be formed to various thicknesses. A polymeric compound deposited on at least a portion of diamond-particle substrate 22 may be in a solid, liquid, or gaseous state prior to and/or during deposition. Deposition of the polymeric compound on at least a portion of diamond-particle substrate 22 may be conducted using any suitable method, including, for example, immersing substrate 22 in a liquid composition comprising the polymeric compound, exposing substrate 22 to a vapor comprising the polymeric compound, and/or immersing substrate 22 in a solution comprising the polymeric compound.

In additional embodiments, at step 104, at least a portion of the polymeric compound in coating 26 deposited on at least a portion of diamond-particle substrate 22 at step 102 may be reacted. In at least one example, the polymeric compound may be reacted by cross-linking at least a portion of the polymeric compound. In various embodiments, the polymeric compound may be cross linked with itself or with other compounds present in coating 26 and/or on substrate 22, using any suitable technique, without limitation. For example, a cross-linking agent may be combined with coating 26 during and/or after formation of coating 26 on at least a portion of surface 24 of diamond-particle substrate 22. Alternatively, a cross-linking agent may be combined with a composition forming coating 26 prior to depositing the composition on at least a portion of surface 24 of diamond-particle substrate 22. In additional embodiments, coating 26 and/or at least a polymeric compound forming coating 26 may be cross linked during a curing process, such as a thermal and/or pressure induced curing process. Additionally, coating 26 and/or at least a polymeric compound forming coating 26 may be cross linked by exposing coating 26 to radiation. In certain embodiments, a cross-linking agent having at least two functional bonding sites may be used to effect cross-linking of at least a portion of coating 26 and/or at least a polymeric compound forming coating 26.

In certain embodiments, coating 26 and/or a polymeric compound in coating 26 may be cured. For example, as detailed in exemplary method 200 illustrated in FIG. 8, at step 202, coating 26 comprising a polymeric compound may be deposited on at least a portion of a diamond-particle substrate 22 (see e.g., step 102 in FIG. 7). In various embodiments, the polymeric compound may comprise at least one amine group.

At step 204, at least a portion of the polymeric compound may be cured using any suitable technique. For example, the polymeric compound may be thermally cured by exposing the polymeric compound, and/or coating 26 comprising the polymeric compound, to an elevated temperature. Additionally, the polymeric compound may be cured by exposing the polymeric compound, and/or coating 26 comprising the polymeric compound, to any suitable type of radiation and/or UV light (i.e., ultraviolet light). In an additional embodiment, the polymeric compound, and/or coating 26 comprising the polymeric compound, may also be exposed to a pressure that is higher or lower than atmospheric pressure to effect curing of the polymeric compound and/or at least a portion of coating 26. Curing may increase a physical and/or chemical stability of the polymeric compound and/or coating 26. For example, curing may increase the stability of coating 26 comprising the polymeric compound when a diamond particle comprising coating 26 is exposed to high pH solutions, low pH solutions, and/or extreme chemical conditions. In at least one embodiment, for example, curing may cause an amide linkage and/or other linkages to form at an amine group on the polymeric compound deposited on diamond-particle substrate 22 at step 202 and/or between an amine group on the polymeric compound and various other compounds in coating 26 and/or on particle substrate 22.

In certain embodiments, diamond-particle substrate 22 may be formed by sintering a plurality of diamond particle particles 21 to form a porous diamond-particle substrate 22. For example, as detailed in exemplary method 300 illustrated in FIG. 9, at step 302, a plurality of diamond particles 21 may be sintered to form diamond-particle substrate 22. Diamond particles 21 may be sintered using any suitable technique. For example, diamond particles 21 may by sintered under high temperatures and/or high pressures, causing adjacent diamond particles 21 to become coupled to one another, producing diamond body 20 having recesses 28 defined between adjoining diamond particles 21 (see e.g., FIG. 2). In an additional embodiment, diamond particles 21 may be coupled together through sintering or any other suitable method to produce a porous diamond mass, which may subsequently be crushed and/or sized into desired porous diamond bodies 20. In various embodiments, a catalyst may be used to facilitate coupling diamond particles 21 together under various conditions. Additionally, diamond particles 21 may be sintered together under high temperature and/or high pressure in the presence of a metal catalyst, such as, for example, cobalt and/or nickel, to form a porous diamond-particle substrate 22, after which the metal catalyst may be extracted from diamond-particle substrate 22.

At step 304, a coating 26 comprising a polymeric compound may be deposited on at least a portion of diamond-particle substrate 22 formed at step 302 (see e.g., step 102 in FIG. 7). Coating 26 comprising the polymeric compound may be formed on at least a portion of recess surface 29 defining recess 28 in diamond-particle substrate 22 (see e.g., FIG. 5). In various embodiments, the polymeric compound may comprise at least one amine group.

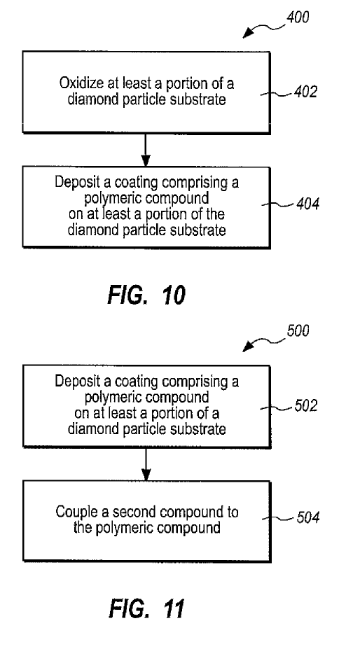

In certain embodiments, at least a portion of diamond-particle substrate 22 may be oxidized prior to depositing coating 26 on at least a portion of diamond-particle substrate 22. For example, as detailed in exemplary method 400 illustrated in FIG. 10, at step 402, at least a portion of diamond-particle substrate 22 may be oxidized through any suitable technique. In at least one embodiment, at least a portion of diamond-particle substrate 22 may be oxidized by exposing diamond-particle substrate 22 to an oxidizing solution comprising an acid compound and/or a peroxide compound. Exposing diamond-particle substrate 22 to an oxidizing solution may assist oxidizing and/or removing impurities, such as organic and/or metallic contamination, from substrate 22.

At step 404, coating 26 comprising a polymeric compound may be deposited on at least a portion of diamond-particle substrate 22, which was oxidized at step 402 (see e.g., step 102 in FIG. 7). In various embodiments, the polymeric compound may comprise at least one amine group.

In at least one embodiment, a second compound may be coupled to a polymeric compound. For example, as detailed in exemplary method 500 illustrated in FIG. 11, at step 502, coating 26 comprising a polymeric compound may be deposited on at least a portion of a diamond-particle substrate 22 (see e.g., step 102 in FIG. 7). In various embodiments, the polymeric compound may comprise at least one amine group.

At step 504, a second compound may be coupled to the polymeric compound in coating 26 that was deposited on at least a portion of diamond-particle substrate 22 at step 502. The second compound may also form at least a portion of coating 26 (see e.g., FIG. 4). For example, the polymeric compound deposited on at least a portion of diamond-particle substrate 22 at step 502 may form at least a portion of a first coating layer 42. Additionally, the second compound coupled to the polymeric compound may form at least a portion of a second coating layer 44. In various embodiments, reactions that may be used to bond the second compound in second coating layer 44 to the polymeric compound in first coating layer 42 may include various suitable reactions, without limitation. For example, the second compound present in second coating layer 44 may be bonded to the polymeric compound in the first coating layer 42 through, for example, a covalent and/or an ionic bond between a functional group on the second compound and an amine and/or hydroxyl group present in or on first coating layer 42. In additional embodiments, the second compound present in second coating layer 44 may be bonded to the polymeric compound in the first coating layer 42 through, for example, hydrogen bonds and/or van der Waals interactions.

### EXAMPLES

The following examples are for illustrative purposes only and are not meant to be limiting with regards to the scope of the specification or the appended claims.

### Reagents

Reagents used in the following examples include Poly(allylamine) (20 wt.% solution in water, Aldrich), 1,2,5,6-diepoxycyclooctane (96%, Aldrich), 1,16-hexadecanedioic acid (>98%, Aldrich), 2-propanol (99.5%, Mallinckrodt chemicals), and palmitoyloleoylphosphatidylcholine (Avanti Polar Lipids, Inc., Alabama).

### Substrates

Diamond-particle substrates used in the following examples include 70 μm diameter diamond particles that were purchased commercially. Porous diamond-particle substrates used in the following examples were prepared by pressing and sintering 2 μm diamond grit that was purchased commercially, and then by crushing and sizing the pressed and sintered diamond grit. The 38-65 μm fraction of the porous diamond-particle substrates was employed. Prior to any surface treatment, diamond-particle substrates and porous diamond-particle substrates were cleaned in piranha solution (70% H₂SO₄:30% H₂O₂) at a temperature of 100° C. for 1 hour, and then thoroughly washed with deionized water.

Silicon wafer substrates used in the following examples include silicon wafer substrates (test grade, n-type, <1-0-0> orientation, 2-6 Ω-cm, UniSil Corporation, California) that were cleaved into ca. 1.5×1.5 cm pieces. Prior to any surface treatment, the silicon wafers were lightly brushed with 2 wt. % sodium dodecylsulfate solution in water and then rinsed thoroughly with Millipore water, and finally plasma cleaned at high power (16 W applied to the RF coil) for 1 minute using a plasma cleaner (model PDC-32G, Harrick Plasma, Ithaca, N.Y.).

### Example 1

### Preparation of Hydrogen-Terminated Diamond Powder

A diamond powder comprising 70 μm diamond-particle substrates was heated in a furnace in an atmosphere of 5% H2 in Ar at 900° C. for 28 hours. The diamond powder was shaken twice during the heating process.

### Example 2

### Cleaning of Oxidized Diamond Powder

A diamond powder comprising 70 μm diamond-particle substrates was cleaned in piranha solution (70% H₂SO₄:30% H₂O₂) at a temperature of 100° C. for 1 hour, and then thoroughly washed with deionized water.

### Example 3

### Preparation of PAAm Functionalized Diamond Powder

A 0.375 wt. % solution of poly(allylamine) (“PAAm”) was made by dissolving 0.75 g of PAAm (20 wt. % solution in water) in 40 ml of Millipore water. 5 g of an oxidized diamond powder prepared according to Example 2 was poured into the 0.375 wt. % solution of PAAm, and the oxidized diamond powder was allowed to react with the 0.375 wt. % solution of PAAm for 1 hour at room temperature. During the reaction, the solution of 0.375 wt. % solution of PAAm was shaken every 5 minutes for ca. 10 seconds. Following the reaction, the diamond powder was sonicated in Millipore water for approximately 10 minutes. The water was changed 4-5 times during this sonication. The PAAm functionalized diamond powder was then captured on a glass frit and washed with Millipore water for approximately 30 minutes. The diamond powder was then dried in a vacuum oven.

### Example 4

### Preparation of PAAm Functionalized Porous Diamond Powder

A 0.375 wt. % solution of PAAm was made by dissolving 0.75 g of PAAm (20 wt. % solution in water) in 40 ml of Millipore water. A porous diamond powder comprising 38-65 μm porous diamond-particle substrates was cleaned in piranha solution (70% H₂SO₄:30% H₂O₂) at a temperature of 100° C. for 1 hour, and then thoroughly washed with deionized water. 5 g of the cleaned porous diamond powder comprising 38-65 μm diamond-particle substrates was poured into the 0.375 wt. % solution of PAAm, and the porous diamond powder was allowed to react with the 0.375 wt. % solution of PAAm for 1 hour at room temperature. During the reaction, the solution of 0.375 wt. % solution of PAAm was shaken every 5 minutes for ca. 10 seconds. Following the reaction, the porous diamond powder was sonicated in Millipore water for approximately 10 minutes. The water was changed 5-6 times during this sonication. The porous diamond powder was then dried in a vacuum oven.

### Example 5

### Preparation of PAAm Functionalized Silicon Wafer Substrates

A silicon wafer was immersed in 10 ml of a 0.1 wt. % solution of PAAm, and the silicon wafer was allowed to react with the 0.1 wt. % solution of PAAm for 35 minutes. The silicon wafer was then washed with Millipore water, and dried with a jet of nitrogen. The resulting PAAm coating on the silicon wafer was found to be 8.7±1.5 Å thick. An advancing water contact angle of the surface of the resulting PAAm coating on the silicon wafer was found to be 32±6°.

### Example 6

### Preparation of Cured PAAm Functionalized Diamond Powder

A PAAm functionalized diamond powder prepared according to Example 3 was cured by heating the PAAm functionalized diamond powder to 115° C. for 2.5 hours in a vacuum oven at reduced pressure. The vacuum for this vacuum oven was provided by a rotary vane pump.

### Example 7

### Preparation of Cross Linked PAAm Functionalized Diamond Powder

A 3.65 wt. % solution of 1,2,5,6-diepoxycyclooctane was prepared in isopropanol. 5 g of a PAAm functionalized diamond powder prepared according to Example 3 was then reacted with the 3.65 wt. % solution of 1,2,5,6-diepoxycyclooctane in a sealed, thick-walled glass reaction vessel at 80° C. for 12 hours. Following the reaction, the PAAm functionalized diamond powder was sonicated in isopropanol for 5 minutes, during which time the used isopropanol was exchanged with unused isopropanol 3 times. The PAAm functionalized diamond powder was then sonicated in dichloromethane for 5 minutes, during which time the used dichloromethane was exchanged with unused dichloromethane 3 times. The PAAm functionalized diamond powder was then captured on a glass frit and washed with dichloromethane for 15 minutes.

### Example 8

### Preparation of Cross Linked PAAm Functionalized Silicon Wafer Substrates

A 0.6 wt. % solution of 1,2,5,6-diepoxycyclooctane was prepared in isopropanol. A PAAm functionalized silicon wafer substrate prepared according to Example 5 was then reacted with the 0.6 wt. % solution of 1,2,5,6-diepoxycyclooctane in a sealed, thick-walled glass reaction vessel at 80° C. for 12 hours. Following the reaction, the PAAm functionalized silicon wafer substrate was rinsed with isopropanol and then with dichloromethane. The resulting cross linked PAAm coating on the silicon wafer was found to be 9.6±0.6 Å. An advancing water contact angle of the surface of the resulting cross linked PAAm coating on the silicon wafer was found to be 65±8°.

### Example 9

### Surface Analysis

X-ray photoelectron spectroscopy (“XPS”) was performed with an SSX-100 instrument from Surface Sciences using an Al Kα source and a hemispherical analyzer. An electron flood gun was employed for charge compensation, and this charge compensation was further enhanced with a fine Ni mesh ca. 0.5-1.0 mm above the surface. Fourier transform infrared spectroscopy (“FTIR”) was performed with a Magna-IR 560 spectrometer from Nicolet. Spectroscopic ellipsometry was performed with an M-2000 instrument from the J.A. Woollam Company (Lincoln, Nebr.). Advancing water contact angles were measured with a contact angle goniometer, model 100-00 from Ramé-Hart.

XPS performed on an oxidized diamond powder prepared according to Example 2 showed no discernable nitrogen signal. Diffuse reflectance FTIR performed on an oxidized diamond powder prepared according to Example 2 showed no C—H stretches on the material.

XPS performed on a PAAm functionalized diamond powder prepared according to Example 3 showed a nitrogen-to-carbon ratio of 0.036±0.002, measured by the ratio of the N1s to the C1s XPS signals in the XP narrow scans. Additionally, XPS performed on a PAAm functionalized diamond powder prepared according to Example 3 showed an O1s/C1s ratio of 0.121±0.001. Diffuse reflectance FTIR performed on a PAAm functionalized diamond powder prepared according to Example 3 showed clearly defined signals in the C—H stretching region.

XPS performed on a cured PAAm functionalized diamond powder prepared according to Example 6 showed an N1s/C1s ratio of 0.036±0.002. Additionally, diffuse reflectance FTIR performed on a cured PAAm functionalized diamond powder prepared according to Example 6 showed a series of small peaks that appear in the FTIR spectrum at positions expected for amide stretches, such as 1690-1620 cm⁻¹ due to C═O stretching and 1570-1520 cm⁻¹ due to coupled C—H stretching and N—H bending.

XPS performed on a cross linked PAAm functionalized diamond powder prepared according to Example 7 showed an N1s/C1s ratio of 0.025±0.001. XPS performed on a cross linked PAAm functionalized diamond powder prepared according to Example 7 also showed an O1s/C1s ratio of 0.153±0.006, consistent with chemisorption of an 1,2,5,6-diepoxycyclooctane.

### Example 10

### Chemical Stability Tests

A first chemical stability test was performed in this example by immersing a diamond powder to be analyzed into 2.5 M HCl for 38 hours. A second chemical stability test was performed in this example by immersing a diamond powder to be analyzed into 2.5 M NaOH for 38 hours.

Prior to exposure to HCl or NaOH, XPS performed on a PAAm functionalized diamond powder prepared according to Example 3 showed a nitrogen-to-carbon-ratio of 0.036±0.002 on the material. Following exposure to 2.5 M HCl, XPS performed on a PAAm functionalized diamond powder prepared according to Example 3 showed that the N1s/C1s ratios had decreased to 0.024±0.003. Following exposure to 2.5 M NaOH, XPS performed on a PAAm functionalized diamond powder prepared according to Example 3 showed that the N1s/C1s ratios had decreased to 0.026±0.003. The results indicate that approximately one-third of the nitrogen was removed from the PAAm functionalized diamond powder particle surfaces during exposure to each of HCl and NaOH.

An N1s/C1s ratio of a cured PAAm functionalized diamond powder prepared according to Example 6 was measured to be 0.036±0.001 using XPS. After immersion of the cured PAAm functionalized diamond powder in 2.5 M HCl, XPS performed on the cured PAAm functionalized diamond powder showed that the N1s/C1s ratio was 0.034±0.002. Similarly, after immersion of the cured PAAm functionalized diamond powder in 2.5 M NaOH, XPS performed on the cured PAAm functionalized diamond powder showed that the N1s/C1s ratio was 0.036±0.003. Accordingly, following immersion of the cured PAAM functionalized diamond powder in each of HCl and NaOH, the ratio of N1s/C1s on the cured PAAm functionalized diamond powder remained essentially unchanged.

An N1s/C1s ratio of a cross linked PAAm functionalized diamond powder prepared according to Example 7 was measured to be 0.025±0.001 using XPS. The decrease in N1s/C1s ratio of the cross linked PAAm functionalized diamond powder, compared to an N1s/C1s ratio prior to cross-linking of 0.036±0.002, may be due to an increased amount of carbon added to the surfaces of the cross linked PAAm functionalzed diamond powder through chemisorption of 1,2,5,6-diepoxycyclooctane. After immersion of the cross linked PAAm functionalized diamond powder in 2.5 M HCl, XPS performed on the cross linked PAAm functionalized diamond powder showed that the N1s/C1s ratio was 0.023±0.000. Similarly, after immersion of the cross linked PAAm functionalized diamond powder in 2.5 M NaOH, XPS performed on the cross linked PAAm functionalized diamond powder showed that the N1s/C1s ratio was 0.026±0.000. Accordingly, following immersion of the cross linked PAAm functionalized diamond powder in each of HCl and NaOH, the ratio of N1s/C1s on the cross linked PAAm functionalized diamond powder remained essentially unchanged.

For purposes of comparison, stability of a commercially available SPE stationary phase (Phenomenex—Strata NH₂, 55 μM, 70 Å) was also measured. The commercially available SPE stationary phase particles appear to be primarily composed of silica, which makes the Si2p peak (a substrate peak) a better reference peak for XPS than the C1s signal. Prior to stability tests, the N1s to Si2p ratio for the commercially available SPE stationary phase, as measured by XPS, was 0.135±0.002. After immersion of the commercially available SPE stationary phase in 2.5 M NaOH for only six hours, the particles completely dissolved, leaving a clear solution. To further verify the dissolution of the commercially available SPE stationary phase particles, the 2.5 M NaOH solution in which the commercially available SPE stationary phase was dissolved was filtered. The entire solution easily passed through the filter, leaving no material behind. The commercially available SPE stationary phase particles were also immersed in 2.5 M HCl for 36 hr. A small decrease of the N1s/Si2p ratio was observed (down to 0.117±0.012), which indicates that a little less than 15% of the nitrogen-containing coating on the commercially available SPE stationary phase particles had been lost.

### Example 11

### Preparation of PAAm Functionalized Diamond Powder SPE Column

Sorbent material was removed from a commercially available SPE column (Phenomenex—Strata NH₂ cartridge, 55 μM, 70 Å, 2.0 cm³ of packing material). 6.2 cm³ of a PAAm functionalized diamond powder prepared according to Example 3 was deposited into the column for use as a stationary phase in the column. The PAAm functionalized diamond powder stationary phase was packed in the column by running water through the column while applying a vacuum pressure to the column, following which the column was vacuum dried.

### Example 12

### Preparation of PAAm Functionalized Porous Diamond Powder SPE Column

The procedure described for Example 11 was essentially followed with the exception that a PAAm functionalized porous diamond powder prepared according to Example 4 was deposited into the column instead of a PAAm functionalized diamond powder prepared according to Example 3.

### Example 13

### Preparation of Cured PAAm Functionalized Diamond Powder SPE Column

The procedure described for Example 11 was essentially followed with the exception that a cured PAAm functionalized diamond powder prepared according to Example 6 was deposited into the column instead of a PAAm functionalized diamond powder prepared according to Example 3.

### Example 14

### Preparation of Cross Linked PAAm Functionalized Diamond Powder SPE Column

The procedure described for Example 11 was essentially followed with the exception that a cross linked PAAm functionalized diamond powder prepared according to Example 7 was deposited into the column instead of a PAAm functionalized diamond powder prepared according to Example 3.

### Example 15

### Preparation of Hydrogen-Terminated Diamond Powder SPE Column

The procedure described for Example 11 was essentially followed with the exception that a hydrogen-terminated diamond powder prepared according to Example 1 was deposited into the column instead of a PAAm functionalized diamond powder prepared according to Example 3.

### Example 16

### Preparation of Oxidized Diamond Powder SPE Column

The procedure described for Example 11 was essentially followed with the exception that an oxidized diamond powder prepared according to Example 2 was deposited into the column instead of a PAAm functionalized diamond powder prepared according to Example 3.

### Example 17

### Elution Using SPE Columns

SPE columns used in this example were each conditioned with 6 column volumes of 0.50 M NH₄OH to deprotonate any protonated amine groups. The SPE columns were then conditioned first with isopropanol, then with 50% isopropanol/50% hexane, and finally with hexane. The analytes used to test the SPE columns in this example were palmitoyloleoylphosphatidylcholine (“POPC”) and 1,16-hexadecanedioic acid. POPC was loaded into the conditioned SPE columns used in this example by depositing a 0.1 mL sample of POPC dissolved in chloroform (0.05 g/mL). 1,16-hexadecanedioic acid was loaded into the conditioned SPE columns used in this example by depositing a 0.1 mL sample of 1,16-hexadecanedioic acid dissolved in a 4:1 mixture (v/v) of chloroform and isopropanol (0.5 g/mL).

SPE was performed on each of the columns in this example by sequentially passing first chloroform, then 2% acetic acid in diethyl ether, and finally methanol through the respective SPE columns. Fractions of the solvents exiting the column were obtained. On a hydrogen-terminated diamond powder SPE column prepared according to Example 15, POPC eluted in the chloroform fraction. On an oxidized diamond powder SPE column prepared according to Example 16, POPC eluted in the methanol fraction, but not in the chloroform fraction or the 2% acetic acid in diethyl ether fraction. Similarly, on a PAAm functionalized diamond powder SPE column prepared according to Example 11, POPC also eluted in the methanol fraction, but not in the chloroform fraction or the 2% acetic acid in diethyl ether fraction. Additionally, on a PAAm functionalized diamond powder SPE column prepared according to Example 11, 1,16-hexadecanedioic acid eluted in the 2% acetic acid in diethyl ether fraction.

### Example 18

### Breakthrough Curves for SPE Columns

Breakthrough curves were obtained for SPE columns in this example using 1,16-hexadecanedioic acid as an analyte for determination of breakthrough volumes of the SPE columns. The SPE columns used in this example were each conditioned with 6 column volumes of 0.50 M NH₄OH to deprotonate any protonated amine groups. The SPE columns were then conditioned first with isopropanol, then with 50% isopropanol/50% hexane, and finally with hexane. After conditioning the SPE columns, a solution comprising 1,16-hexadecanedioic acid was run through the SPE columns. The columns in this example were kept wet and a flow rate of the 1,16-hexadecanedioic acid solution was kept constant while the breakthrough curves were being obtained.

Equal volumes of the fractions eluting from the column were collected in separate vials. The samples were then analyzed using electrospray ionization mass spectrometry (“ESI-MS”) to obtain the breakthrough curves based on the presence of 1,16-hexadecanedioic acid in the collected fractions. The breakthrough curves had sigmoidal shapes. The breakthrough volume was taken from the point on the breakthrough curve corresponding to 5% of the average value at the maximum (i.e., the breakthrough curve plateau region).

From these breakthrough curves, a column capacity for a PAAm functionalized diamond powder SPE column prepared according to Example 11 was found to be 0.16 mg, a column capacity for a cured PAAm functionalized diamond powder SPE column prepared according to Example 11 was found to be 0.11 mg, and a column capacity for a cross linked PAAm functionalized diamond powder SPE column prepared according to Example 12 was found to be 0.11 mg. Additionally, a column capacity for a PAAm functionalized porous diamond powder SPE column prepared according to Example 10 was found to be 3.26 mg based on a breakthrough curve obtained for this column.

### Example 19

### Formation of C18 Phase on PAAm Functionalized Diamond Powder

A PAAm functionalized diamond powder prepared according to Example 3 was treated with 0.5M ammonia solution so as to deprotonate the amine groups of PAAm, and thereby make the surface more reactive towards Octadecylisocyanate. Approximately 6 wt. % solution of Octadecylisocyanate was prepared in anhydrous Tetrahydrofuran (“THF”), and the PAAm functionalized diamond powder was poured into the solution. The PAAm functionalized diamond powder was then reacted in the solution in a closed thick-walled glass tube at a temperature of 80° C. for 12 hours. Subsequently, the diamond powder was sonicated for 5 minutes in each of THF and then dichloromethane. Each of the THF and the dichloromethane was changed 4 times during sonication. The reaction formed a C18 phase on the PAAm functionalized diamond powder.

### Example 20

### Elution Using C18 SPE Column

An SPE column (“C18 SPE column”) was prepared using the diamond powder on which a C18 phase was formed according to Example 19 as a stationary phase. Diazinon was used as an analyte in this example. A breakthrough volume was calculated to determine the capacity of the C18 SPE column. The breakthrough curve indicated that the capacity of the C18 SPE column for Diazinon was 0.048 mg. Percent recovery studies were also performed on the C18 SPE column to determine its efficiency. Percent recovery for Diazinon was observed to be 98.7% on the C18 SPE column.

The preceding description has been provided to enable others skilled in the art to best utilize various aspects of the exemplary embodiments described herein. This exemplary description is not intended to be exhaustive or to be limited to any precise form disclosed. Many modifications and variations are possible without departing from the spirit and scope of the instant disclosure. The embodiments described herein are in all respects illustrative and not restrictive.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

1. A functionalized particle, comprising:
a diamond-particle substrate;
a coating positioned on at least a surface portion of the diamond-particle substrate, the coating comprising at least one polymeric compound having at least one amine group;
wherein the at least one polymeric compound is at least partially, covalently reacted to form at least one carbon-nitrogen bond; and
wherein the coating is substantially stable in a 2.5 M HCl solution and a 2.5 M NaOH solution.

2. The functionalized particle of claim 1, wherein the at least one polymeric compound comprises at least one of a homopolymer and a copolymer.

3. The functionalized particle of claim 1, wherein the diamond-particle substrate is porous.

4. The functionalized particle of claim 1, wherein the diamond-particle substrate comprises a plurality of sintered diamond particles.

5. The functionalized particle of claim 1, wherein the diamond-particle substrate comprises polycrystalline diamond.

6. The functionalized particle of claim 1, wherein the at least one polymeric compound is at least partially cured to at least partially cross link the at least one polymeric compound.

7. The functionalized particle of claim 1, wherein the coating comprises the reaction product of the at least one amine group on the at least one polymeric compound and a cross-linking agent.

8. The functionalized particle of claim 1, further comprising a second compound that is coupled to the at least one amine group on the at least one polymeric compound.

9. The functionalized particle of claim 8, wherein the second compound comprises at least one of a branched alkyl chain, a straight alkyl chain, and an aromatic ring.

10. The functionalized particle of claim 1, wherein the diamond particle comprises a micron-sized diamond particle.

11. The functionalized particle of claim 1, wherein the diamond particle comprises a nanodiamond particle.

12. The functionalized particle of claim 1, wherein the at least one polymeric compound comprises at least one of polyallylamine, polyallylamine hydrochloride, polyethylenimine, polylysine, polyvinylamine, chitosan, trimethylchitosan, polydiallyldimethyl ammonium chloride, poly(N,N′-dimethylaminoethylmethacrylate), poly(2-vinylpyridine), poly(4-vinylpyridine), polyvinylimidazole, poly(2-(dimethylamino)ethyl acrylate), poly(2-aminoethyl methacrylate) hydrochloride, and polyoxazoline.

13. The functionalized particle of claim 1, wherein the at least one polymeric compound comprises a polymeric compound formed from at least one of an allylamine monomer, a vinylamine monomer, an ethylenimine monomer, a lysine monomer, an arginine monomer, a histidine monomer, a 2-isocyanatoethyl methacrylate monomer, an aziridine monomer, a 1-vinylimidazole monomer, a 1-vinyl-2-pyrrolidone monomer, a 2-vinylpyridine monomer, a 4-vinylpyridine monomer, a 2-(dimethylamino)ethyl acrylate monomer, a 2-aminoethyl methacrylate hydrochloride monomer, and/or a 2-(tert-butylamino)ethyl methacrylate monomer, and an oxazoline monomer.

14. The functionalized particle of claim 1, wherein the at least one polymeric compound comprises a polymeric compound formed from at least one monomer comprising an amine group and at least one of a 2-hydroxyethylacrylate monomer, a styrene monomer, a 1,3-butadiene monomer, a methyl methacrylate monomer, a methyl acrylate monomer, a butyl acrylate monomer, a dodecyl methacrylate monomer, an acrylonitrile monomer, an acrylic acid monomer, a methacrylic acid monomer, a 4-vinylbenzyl chloride monomer, a 4-(trifluoromethyl)styrene monomer, a 3-nitrostyrene monomer, a vinyl ether monomer, a stearyl acrylate monomer, and a vinyl acetate monomer.

15. A functionalized particle, comprising:
a diamond-particle substrate;
a coating positioned on at least a surface portion of the diamond-particle substrate, the coating comprising at least one polymeric compound having at least one amine group;
wherein the coating is substantially stable in a 2.5 M HCl solution and a 2.5 M NaOH solution.

16. (canceled)

17. A functionalized particle, comprising:
a diamond-particle substrate;
a coating positioned on at least a surface portion of the diamond-particle substrate, the coating having a surface that includes at least one hydrophobic portion and at least one hydrophilic portion.

18. The functionalized particle of claim 17, wherein the coating comprises at least one polymeric compound having at least one amine group.

19. (canceled)

20. A separation apparatus comprising:
a stationary phase, the stationary phase comprising:
a plurality of diamond particles; and
a coating positioned on at least a surface portion of the plurality of diamond particles, the coating comprising at least one polymeric compound having at least one amine group;
wherein the at least one polymeric compound is at least partially cross linked.

21. A method for forming a functionalized particle, comprising:
depositing a coating on at least a portion of a diamond-particle substrate, the coating comprising at least one polymeric compound having at least one amine group;
cross linking at least a portion of the at least one polymeric compound during and/or after the coating has been deposited on at least a portion of the diamond-particle substrate.

22. The method of claim 21, wherein cross linking at least a portion of the at least one polymeric compound includes curing at least a portion of the at least one polymeric compound.

23. The method of claim 21, wherein cross linking at least a portion of the at least one polymeric compound further comprises reacting the at least one amine group with a cross-linking agent.

24. The method of claim 21, wherein at least a portion of the at least one polymeric compound is cross linked prior to depositing the coating on at least a portion of the diamond-particle substrate.

25. The method of claim 21, further comprising sintering a plurality of diamond particles to form the diamond-particle substrate, wherein the formed diamond-particle substrate is porous.

26. The method of claim 21, further comprising oxidizing at least a portion of the diamond-particle substrate.

27. The method of claim 21, further comprising coupling a second compound to the at least one amine group on the at least one polymeric compound.

28. A method for forming a functionalized particle, comprising:
depositing a coating on at least a portion of a diamond-particle substrate, the coating comprising at least one polymeric compound having at least one amine group;
curing the coating to cross link at least a portion of the at least one polymeric compound.

29. The method of claim 28, wherein curing the coating comprises exposing the coating to at least one of heat, radiation, and UV light.

30. A method for forming a functionalized particle, comprising:
depositing a coating on at least a portion of a diamond-particle substrate;
reacting the coating to form a surface that includes at least one hydrophobic portion and at least one hydrophilic portion.

31. The method of claim 30, wherein reacting the coating includes cross linking at least one polymeric compound in the coating.

32. The functionalized particle of claim 1, wherein the amine group is a primary amine group.

33. The functionalized particle of claim 1, wherein the coating has a surface that includes at least one hydrophobic portion and at least one hydrophilic portion.

34. A method of separating a mixture comprising:
passing a sample through a stationary phase, the stationary phase comprising:
a plurality of diamond particles; and
a coating positioned on at least a surface portion of the plurality of diamond particles, the coating comprising at least one polymeric compound having at least one amine group;
wherein the at least one polymeric compound is at least partially cross linked.

35. The method of claim 34, wherein the method is a solid phase extraction method.
